(19) United States
(12) Patent Application Publication
(10) Pub. No.: US 2016/0163079 A1
(43) Pub. Date: Jun. 9, 2016

(54) Electronic Greeting Card System

(71) Applicant: OCCASION GREETINGS, LLC., Pasadena, CA (US)

(72) Inventor: Joseph Lee, Pasadena, CA (US)

(73) Assignee: OCCASION GREETINGS, LLC., Pasadena, CA (US)

(21) Appl. No.: 14/561,147

(22) Filed: Dec. 4, 2014

(51) Int. Cl. G06T 11/60; G06Q 30/06

(52) U.S. Cl. CPC G06T 11/60; G06Q 30/0621; G06T 2200/24

(57) ABSTRACT

The present invention provides an electronic greeting card (“e-card”) system that allows the sender to modify the original dialogue of the e-card. This unique personalized e-card feature is different from the sender's conventional ability to create personalized content in the card from scratch. The system also contains the ability to organize sent and draft e-cards through a save to folder option, the ability to restrict ownership to only the sender who purchased the e-card, an optional gift card that is both visual and wrapped, and an opening date where the recipient cannot open the e-card and/or the gift card until the opening date arrives.

### BACKGROUND OF THE INVENTION

1. Field of Invention

The present invention relates to systems for sending electronic greeting cards (“e-cards”), and more specifically, to a system for configuring the greeting cards prior to delivery.

2. Description of Related Art

A conventional greeting or post card is an illustrated card expressing a particular sentiment, such as friendship, celebration, or sorrow. Greeting cards are typically given on a special occasion, such as a birthday, a holiday such as Christmas, or generic universally accepted non-religious occasion such as Seasons Greetings or Happy Holidays. Additionally, greeting cards are given on smaller occasions, such as conveying thanks or conveying other feelings. Traditional greeting cards are inexpensive, folded, hardcopy cards, packaged within an envelope that come in a variety of styles, and are mass distributed by a merchant such as Hallmark Cards or American Greetings. Some greeting cards have elaborate designs, are handmade, and are expensive. Over time, greeting cards have become more and more electronic, from having embedded music to be sent over the Internet. Greeting cards sent over the internet are electronic greeting cards, which may also be referred to herein as e-cards, ecards, greeting cards, or simply, a card.

Electronic greeting cards are similar to the traditional greeting cards, except for being selected and delivered using a digital medium such as the Internet. Electronic greeting cards are made available by merchants, usually on various Internet sites, where they are typically sent to a recipient by email. A recipient may also be referred to herein as a receiver and the sender may also be referred to herein as a purchaser or user. Electronic greeting cards are favored by some purchasers over hardcopy greeting cards because they can easily be sent to multiple recipients at once and they are viewed as being more environmentally friendly because they do not use paper.

Electronic greeting card merchants display a wide variety of electronic greeting cards online for customers to review and select. Conventionally, the greeting card sender will select a card, personalize it, and then have the merchant send it to a recipient's email on the sender's behalf The conventional personalization includes adding a message, a photo, or a video. The message is created from scratch or by the merchant.

A problem with conventional electronic greeting cards is that the sender has limited configuration options to personalize the original dialogue of the greeting card. In other words, the sender cannot adjust the language that already exists when viewing greeting card for purchase. Although the sender already has the ability to add their own personalized write-up or comments from scratch, the sender lacks the ability to modify the original dialogue that was thought up by the greeting card merchant.

Another problem with conventional electronic greeting cards is that the sender cannot easily organize the greeting cards before or after delivery. For example, a user does not have a “save to folder” option that allows them to save this version of the greeting card.

A further problem is that merchants have trouble limiting the ownership of the greeting card to the purchaser, such that they are not continually re-sent by recipients. This problem is amplified is the recipient has the ability to keep or save the greeting card. The merchant may want this one side ownership, such that the recipients cannot re-send the card, either due to the personalized nature of the card or due to the card not having being purchased by the recipient. It would be ideal if the merchant could limit the ownership of the greeting card to the purchaser/sender, such that only the sender owns the card, and only the sender can make any number of modifications to his purchased greeting card, such that the sender can send modified versions of the e-card an unlimited number of times.

U.S. Patent Publication Number 2012/0123895 to Horvitz allows users to personalize or customize a greeting card using film content from motion picture studios and television networks. For example, a user can define a card that includes one or more scenes from an old Bogart classic as content for a greeting card or a greeting card that includes one or more “Three Stooges” clips or other library clips.

U.S. Patent Publication Number 2014/0031084 to Johnson presents a printed or electronic greeting card system capable of configuration by the purchaser, where the system may permit electronics to be reused/recycled from a previous purchase or card receipt, if desired. The number of reuses may or may not be limited. In the next step, the customer either configures the electronics technology within the card for the telephony connection or goes to online/website/app location to configure the connection processes.

However, Horvitz and Johnson fall short because their personalizing is adding material from scratch, not modifying the original dialogue of the card. Additionally, Horvitz and Johnson do not provide an organization system for saving messages. Further, Johnson's reuses refer to the electronics to be recycled, not a one sided only reuse by the sender.

### SUMMARY OF THE INVENTION

The present invention provides an electronic greeting card (“e-card”) system that allows the sender to modify the original dialogue of the greeting card, providing a unique combination of a personalized card with a professional write-up and design. This unique personalized e-card feature is different from the sender's conventional ability to create personalized content in the card from scratch. The greeting card may be delivered as an attachment on an email. The system also contains the ability to organize sent and draft e-cards through a save to folder option. The system further allows the manufacturer to restrict ownership to only the sender who purchased the greeting card, such that only the sender that purchaser the e-card can send the greeting card an unlimited number of times with an unlimited number of personalized modifications. Additionally, the system allows the sender the option to select a gift card that is both visual shown and wrapped as another attachment for the email. Although the greeting card and a gift card/note are illustrated as being separate attachments in some embodiments, in a preferred embodiment the gift card will be attached to the greeting card itself so the recipient will only see the envelop icon when he/she receives the card. Further, both the greeting card attachment and/or the wrapped gift card attachment may contain an opening date, where the recipient can open the wrapped gift card and/or the greeting card on or after the opening date.

In one embodiment, a system comprises: a selection module configured to allow a sender to select an electronic greeting card having original dialogue; a configuration module, wherein the configuration module allows the sender to modify the original dialogue of the electronic greeting card to create personalized dialogue on the electronic greeting card; and a sending module configured to send the electronic greeting card.

In another embodiment, a system comprises: a configuration module, wherein the configuration module receives an electronic greeting card selected by a sender having original dialogue, wherein the configuration module allows the sender to modify the original dialogue of the electronic greeting card to create personalized dialogue on the electronic greeting card; a purchasing module that allows the sender to purchase or finalize a selection of the electronic greeting card; and a sending module configured to send the electronic greeting card.

In a further embodiment, a method comprises the steps of: receiving an electronic greeting card selected by a sender having original dialogue; modifying the original dialogue of the electronic greeting card to create personalized dialogue on the electronic greeting card; and sending the electronic greeting card to a recipient.

An advantage of the present invention is that the sender has the ability to personalize content that is already professional and desirable, in terms of being created by a manufacturer and being associated with a drawing of the e-card. This is unique because the system is not asking the sender to be creative and create the entire dialogue, instead, the system is allowing the sender to modify it with special insertions such as a person's name, an expression a person is known for, a favorite restaurant, highlighting a person's unique habit, etc.

Another advantage of the present invention is it provides an organized system where the sender can save to a folder both draft or sent greeting cards. This save to folder feature allows an e-card system that can be organized according to the sender's preferences, such as by occasion, by recipient, by modification, etc.

A further advantage is the system ties ownership to the sender who actually purchased the card such that only the sender can send an unlimited number of modified versions of the purchased e-card an unlimited number of times. In one embodiment, control of the ownership is tied to the purchaser's email address. This allows a merchant to limit ownership of the original and modified cards to the purchaser and not the recipient.

Additionally, the system allows a separately purchased gift card or gift note to be attached to a greeting card email. This contains advantages in that it is a visual presentation of a gift card or note and it is wrapped, both of which convey immediately to the recipient that a gift has been received. Further, an opening date may be advantageously attached to the gift card/note (or the electronic greeting card) that allows the sender to delay opening until not before a special occasion, such as Christmas or the recipient's birthday.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates an electronic greeting card system according to an embodiment of the invention;

FIGS. 2-3 illustrate a configuration module of the system according to an embodiment of the invention;

FIG. 4 illustrates a recipient's email inbox according to an embodiment of the invention;

FIGS. 5-13 illustrate a sample greeting card from the sender's perspective as the sender prepares the greeting card for purchase according to an embodiment of the invention;

FIGS. 14-18 illustrate the sample greeting card from the recipient's perspective after the recipient opens the greeting card according to an embodiment of the invention; and

FIG. 19 illustrates a process of using the electronic greeting card system according to an embodiment of the invention.

### DETAILED DESCRIPTION OF EMBODIMENTS

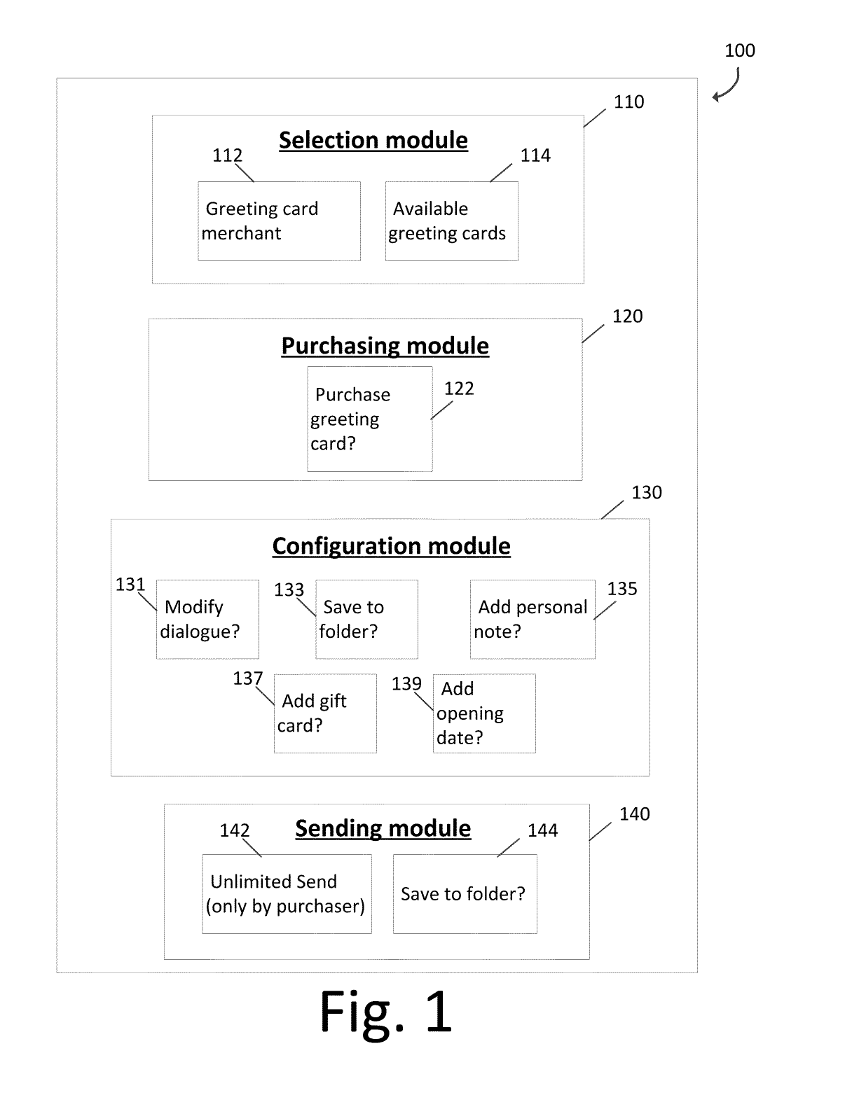

Further features and advantages of the invention, as well as the structure and operation of various embodiments of the invention, are described in detail below with reference to the accompanying FIGS. 1-19, wherein like reference numerals refer to like elements.

Although the present invention is described at times in the context of a one page greeting card, this is for simplicity of explanation, and one with skill in the art realizes that greeting cards can have more than one page (e.g., front cover, back cover, and two inside covers). Additionally, although the invention is described in terms of specific modules, more or less modules can be used to accomplish the invention, without departing from the spirit of the invention.

The greeting card of the present invention is a new type of electronic greeting card which is designed with the functionality to allow for a very personal message to connect ‘two people at a time.’ This greeting card is received as an envelope icon attached to an email. Once the envelope icon is launched by double clicking on it, the front of the greeting card appears on the screen. The front of the card only has the drawings with initial dialogue and header. The initial dialogue the first words spoken in a scene. Additional dialogue will appear when the computer's ‘enter’ button is hit, the ‘continue’ button is chosen, the iPad, iPhone, etc. screen is touched or swiped. Additional dialogue is the next words spoken in the scene, typically by the other characters in the scene. Both the initial dialogue and the additional dialogue can be modified by the sender.

On the inside of the card there is an area where the sender can write a personal note. The number of lines will be unlimited. Finally, when the recipient opens the card there will be a line on the inside which reads, ‘reply to sender’ at the bottom of the message. This will allow the recipient to respond back to the sender's email address.

This greeting card will be available on Applicant's website and all other online stores thru various apps (Apple, Android, etc.). One of the key functionalities of the card will be the ability to modify the dialogue of the card. The sender can modify the dialogue by clicking on the button at the bottom of the card which reads: ‘Modify dialogue.’ Once the sender clicks this icon, they can change the wording and/or add to it. If they do change the wording, a statement at the bottom of the card will appear which will read, ‘Dialogue enhanced by sender.’ When the sender moves to the next line of dialogue what he/she has modified is saved automatically. The sender can continue to modify the dialogue until they get to the end and click on the ‘save’ button. If the sender does not initially choose the ‘Modify dialogue’ option, they can do so at any time as the ‘Modify dialogue’ button will continue to appear until it is selected.

FIG. 1 illustrates an electronic greeting card system 100 according to an embodiment of the invention. The system 100 includes a selection module 110, a purchasing module 120, a configuration module 130, and a sending module 140. The system 100 allows the sender to modify original dialogue of a professional greeting card, a save to folder feature, sender only ownership of the card, and a gift card that is visibly wrapped and contains an opening date.

The selection module 110 comprises a greeting card merchant 112 and available greeting cards 114. The greeting card merchant 112 may be an online retailer such as Applicant's website or Amazon, or the merchant 112 may be an App which may be downloaded on the Android play store or the Apple Store. The merchant may display the available greeting cards 114 by methods known by those with skill in the art, such as sorting by occasion, sorting by price, or viewing all e-cards.

In the purchasing module 120, the sender purchases a greeting card 132. In one embodiment, the purchase price is free, and the purchase is more of a final selection of the desired card. One of ordinary skill in the art realizes that greeting card could be offered under different pricing plans, such as a free purchase via advertising banners, purchased individually, or a membership plan.

To purchase, after the sender is on Applicant's website (or other apps set up to handle), the sender will need to click on the particular card they want to view and it will launch/open on their screen. After the sender has viewed and configured the card, a button/icon will appear at the bottom of the card which will ask—‘do you want to add this to your cart?’ ‘YES or NO?’ If they choose ‘YES’ it will be added to their cart and the card will close. If no, the greeting card will simply close. In one embodiment, once they check out and pay for the greeting card(s), the greeting card(s) will be sent to the Sender as an icon to their email address. Once they receive it, they can save it to a folder to send out at a later date or launch it, modify as they want, and send accordingly.

The configuration module 130 allows the sender to modify dialogue 131, save e-cards to a folder 133, add a personal note 135, add a gift card 137, and add an opening date 139. The modifying dialogue feature 131 allows the sender may modify the language of the existing card. In one embodiment, the sender modifies the dialogue itself In another embodiment, the sender modifies a header located above the dialogue.

This unique modification feature 131 advantageously allows the sender to personalize content that is already professional, in terms of being created by a manufacturer, creative, and being associated with a drawing on the e-card. The sender can make minor changes such as adding a name, changing punctuation, or changing font size/style. Alternatively, the sender can make a more significant change such as changing the punchline of the card to be more appropriate for the recipient. A sender may want to make changes because of the sender's relationship with the recipient, the sender previous personal experiences with the recipient, to make the card more appropriate, or to make the card funnier

The save to folder feature 133 gives the sender the ability to save modifications that have already been sent or have not yet been sent. This unique feature advantageously allows the sender to personalize content and wait till later to send or organize already sent messages.

The add personal note feature 135 is a conventional feature known by those with skill in the art for personalizing a greeting card. The personal note 135 is typically created from scratch. The add personal note feature 135 is different from the unique modify dialogue feature 131 because the personal note 135 is not modifying existing language of the purchased greeting card.

A gift card is a money equivalent that is restricted to a particular retailer and is often issued when the purchaser does not have a specific gift in mind from the particular retailer. A gift note is a personalized description by the sender of a future gift such as “one romantic dinner,” “a trip to Hawaii,” “a new set of your favorite golf clubs,” etc. Generally adding a gift card/note is a conventional feature that is known in the prior art. However, having a gift card 137 that is visually shown as an attachment and/or wrapped is a unique feature. Advantageously, a visual and/or wrapped gift card/note builds anticipation for what the gift card/note may be.

Gift cards bought online from Amazon, Apple, Stubhub, etc. can be sent along with this greeting card as a gift card icon. During configuration of the greeting card, at the bottom of the greeting card, there is an icon which reads ‘Add Gift Card or Gift Note.’ If the sender wants to add a gift card/note to the greeting card, he/she will need to double click on the ‘Add Gift Card or Gift Note’ button and a menu of various e-retailers will appear (e.g., Amazon, Apple, Stubhub, etc.). Once the sender has purchased the gift card, the gift card will appear on the last page of the greeting card. The buyer will need to input the following information: Amount: (value of the gift card), Redeem at: (website where the gift card can be redeemed at), and Reference #: (the number needed to redeem the gift.).

Another icon will appear asking, ‘Gift wrap card?’ Yes or No? If the sender chooses yes, the card will automatically be wrapped with color wrapping paper and a bow. If the sender wants to change the color/type of wrapping paper he/she simply needs to click on the gift card icon and the color/type of wrapping paper will change. Every click will lead to a different color/type of paper.

Additionally, the add opening date feature 139 is unique and advantageously allows the sender to pick a date that the recipient cannot open before (e.g., Christmas). The opening date feature 139, like the wrapped gift card, further builds anticipation for what the gift or e-card may be. Alternatively, the sender may use this opening date feature to send the card and be sure that the gift has been sent, as the sender may be very busy the day of the actual occasion. In another embodiment, the opening date is attached to the e-card as well or separately.

The opening date feature 139 asks the sender if he/she wants to choose a date to have the recipient open the gift (specific date—December 25^{th}, the person's birthday, etc.). If the gift opening has been set for a specific date then when the recipient puts the cursor over the gift icon, a message will appear stating, ‘Please wait until xx/xx/xx.’ If no date is indicated or it is now the scheduled opening date, when the recipient puts the cursor over the gift box it will read, ‘Double click to ‘Unwrap gift.’ The other option to unwrap the gift card is to click on the ‘Unwrap gift’ icon.

The sending module 140 comprises and unlimited send feature 142 and a save to folder feature 144. The unlimited send feature 142 allows the sender to send the card an unlimited number of times with an unlimited number of modifications. This unlimited send feature is unique because it limits the sending and modifications to the sender that purchased the greeting card, and not to the recipient. The recipient can reply to the sender by email, but the recipient does not have ownership of the greeting card. This one sided sending feature 142 prevents recipients from being able to have ownership of the card that they did not purchase or modify themselves.

The buyer/sender can use the same card an unlimited number of times. Once they purchase a card, they own it and can re-use it as often as they would like. However, the recipient will not be able to use/send the card. The programming of this greeting card will not allow the recipient to do this. The recipient will only be able to read the card and respond under the ‘respond to sender’ section. This restriction will be controlled by tying the buyer's email address to the specific greeting card he/she bought.

The idea is that once the sender has purchased this greeting card, he/she owns it and can save it on his/her computer. Therefore, this person can modify the card as many times as he/she likes and send it to anyone he/she would like to. As an example, if it is a Christmas card he/she may want to send it individually with a personal note to 50 friends, relatives, etc. In this example the sender would send the card 50 times to 50 people individually.

The save to folder feature 144, like the save to folder feature 133, allows the sender to organize his greeting cards. Unlike the feature 133, the save to folder feature 144 is for greeting cards that have already been sent or purchased. The sender could organize the greeting cards by greeting card, by occasion, by recipient, by year, or by any other way.

After the Sender has finished modifying the dialogue and writing their personal note they will then click the ‘Save’ button. This ‘save’ selection will allow the sender to save to one of their folders under the three digit code: .ogt. As an example, a birthday card sent to Cindy could be named—cindybday.ogt. The card will be saved but will also still be displayed on the sender's screen. In order to proceed to the next screen the sender will need to touch/swipe the screen, hit enter on the keyboard, or choose ‘continue’ button and the next screen will appear. The next screen will indicate the options of ‘Add Gift Card or Gift Note’ or ‘Send.’ These two buttons (‘add gift card or gift note’ and ‘send’) will be found below the card. If the Sender chooses ‘send’, they will need to add the recipient's email address, click the ‘Send’ button and the card/note will turn into an envelope icon and be sent as an email attachment to the intended Receiver. If the Gift Card/Note option was chosen and the gift card was purchased, the gift card will be attached to the greeting card email. At this point, the sender can click ‘Send’ to send the greeting card. If the sender has saved the card to a folder then he/she can simply attach it to an email like any other document. It is important to note, the greeting card will still appear as an envelope when attached to an email.

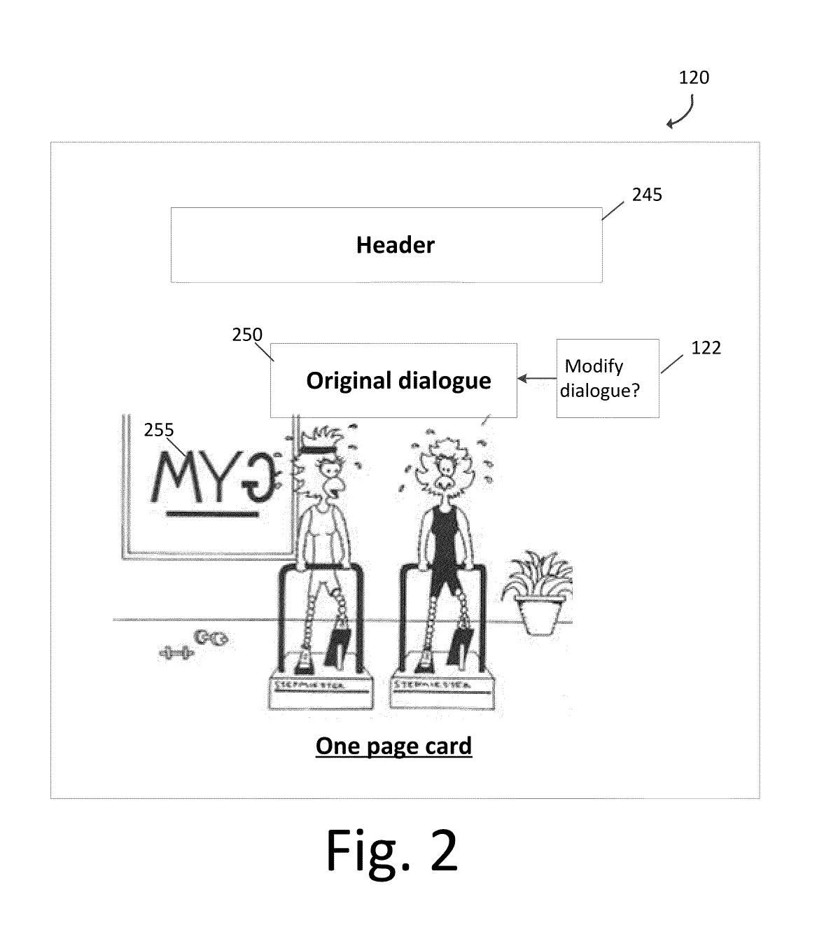

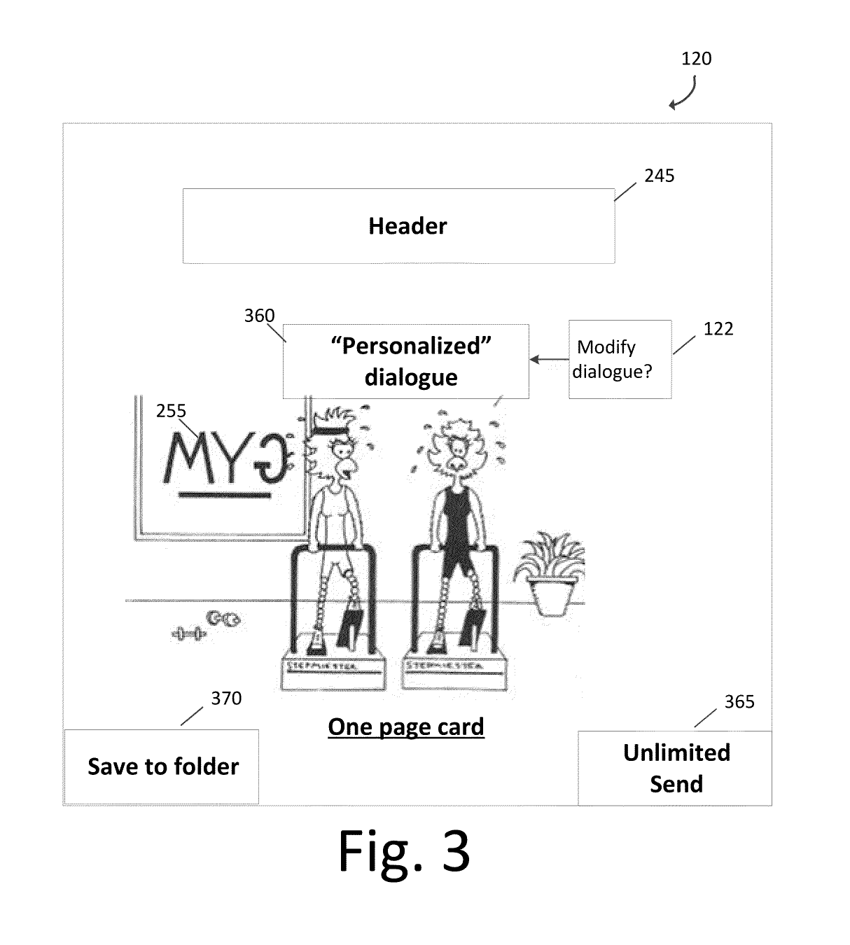

FIGS. 2-3 illustrate the configuration module 130 of the system 100 according to an embodiment of the invention. The configuration module 130 allows the sender to modify dialogue, save drafts to a folder, add a personal note (not shown), and takes the sender to the purchasing and sending modules.

In FIG. 2, the configuration module 130 includes a header 245, an original dialogue 250 near the modify dialogue feature 131, and a professional design 255. For clarity, a one page greeting card is illustrated although many conventional greeting cards have more than one page. Headers 245 are a part of greeting card known by one with skill in the art. The header 245 can be a title, an introduction for the occasion (e.g., Happy Birthday), a precursor to the punchline on the next page (e.g., “Earlier in the week”).

The original dialogue 250 is the written part of the card created by the card manufacturer. The original dialogue can be professional, funny, creative, surprising, or elicit any other emotion known by greeting card manufacturers. The original dialogue can comprise initial dialogue by one character followed by additional dialogue from other characters in a scene. The modify language feature 131 allows the sender to modify the original dialogue 250. The professional design 255 distinguishes the greeting card from a blank sheet of paper that the sender could easily create from scratch.

In FIG. 3, the sender modified the original dialogue 250 to create personalized dialogue 360. The personalized dialogue 360 is unique from a conventional blank section of a greeting card that allows the sender to write anything. The personalized dialogue 360 is a modified form of the original dialogue 250. In another embodiment, the sender can also modify the header 245. FIG. 3 also illustrates that the sender has an unlimited send feature 365 and a save to folder feature 370.

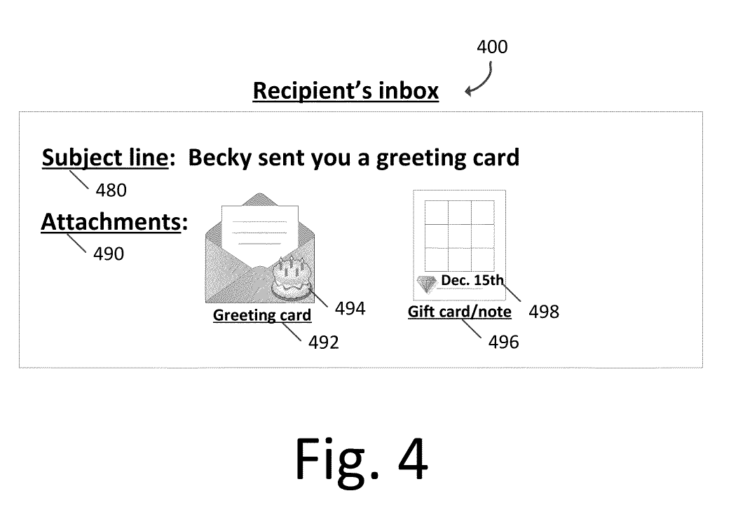

FIG. 4 illustrates a recipient's email inbox 400 according to an embodiment of the invention. The inbox 400 includes a subject line 480 and attachment field 490. The subject line 480 introduces an email and is well known in the art. The attachment field 490 is also well known in the art and contains something for the recipient to open.

The attachment field 490 includes a greeting card 492 with a visual indication of the occasion 494 and an optional gift card/note 496 with an opening date 498. Although the greeting card 492 and gift card/note 496 are illustrated as being separate attachments, this is mostly for illustration, as in a preferred embodiment, the gift card will be attached to the greeting card itself so the recipient will only see the envelop icon when he/she receives the card. The recipient can open the greeting card 492 to view the ecard or the gift card/note 496 to view the gift or note. In one embodiment, the greeting card 492 also has an opening date. In another embodiment, the gift card/note 496 is visually shown as an attachment and is wrapped.

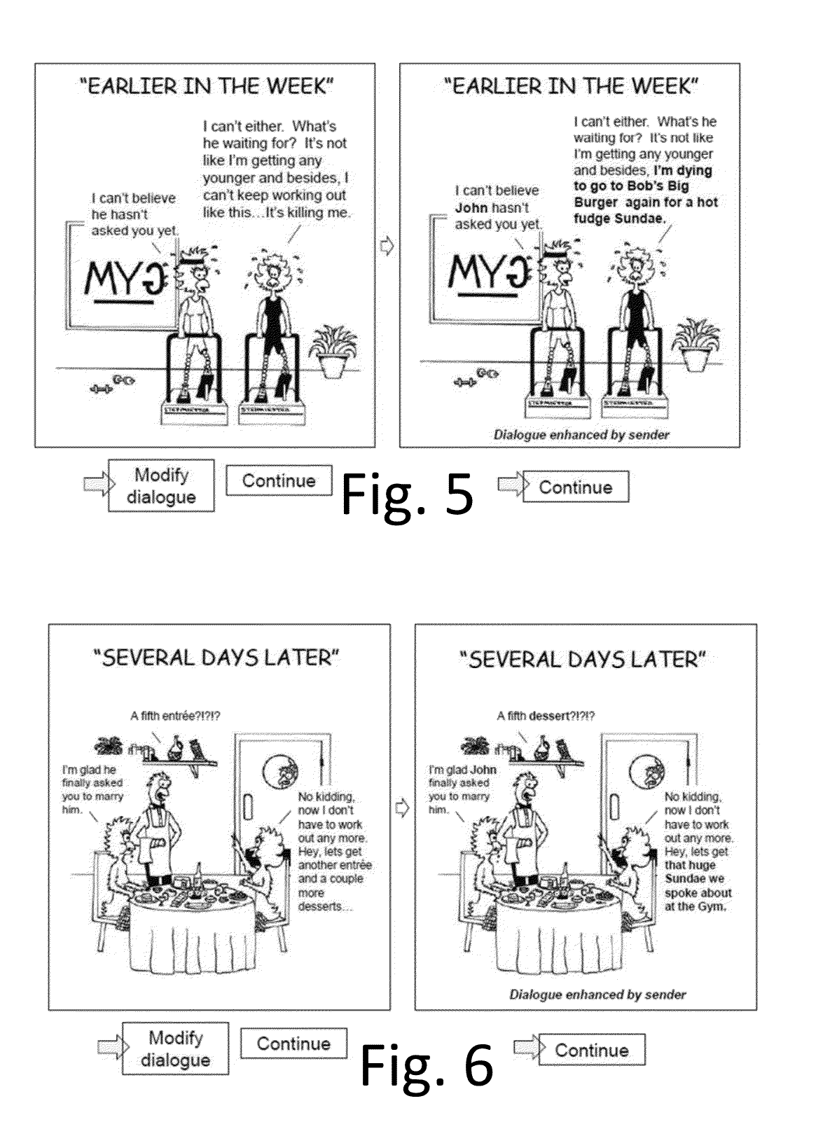

FIGS. 5-13 illustrate a sample greeting card from the sender's perspective as the sender prepares the greeting card for purchase according to an embodiment of the invention.

FIG. 5 illustrates a first scene and pages of a greeting card before and after modification by the sender. On the left of FIG. 5, is the original dialogue prepared by a manufacturer and a screen the sender sees when being presented with the option to modify the dialogue. In one embodiment, the sender clicks on ‘Modify dialogue’ when he/she wants to change the original dialogue. If the sender modifies the dialogue, the comment “Dialogue enhanced by sender” will appear on the next screen. When the sender is ready to go to the next line of dialogue, he/she needs to touch and/or swipe the screen, hit ‘enter’ on the keyboard, or click the ‘continue’ button. On the right of FIG. 5, the sender has modified the original dialogue to insert a name and a favorite restaurant and food. This personalization is likely meaningful to the sender and the recipient.

Advancing the dialogue by hitting enter or similar provides a unique look and feel to the sender and the recipient. Specifically, the original dialogue or the personalized dialogue is dispersed among a plurality of pages and/or a plurality of scenes. Then, a recipient advances through the plurality of pages and/or the plurality of scenes by hitting an enter button, clicking a continue button, clicking an arrow button, swiping a screen, or touching the screen.

FIG. 6 illustrates a second scene and pages of a greeting card before and after modification by the sender. Like discussed above with respect to FIG. 5, the sender will click on ‘Modify dialogue’ when he/she wants to change the original wording and when the sender is ready to go to the next line of dialogue he/she needs to touch and/or swipe the screen, hit ‘enter’ on keyboard, or choose ‘continue.’

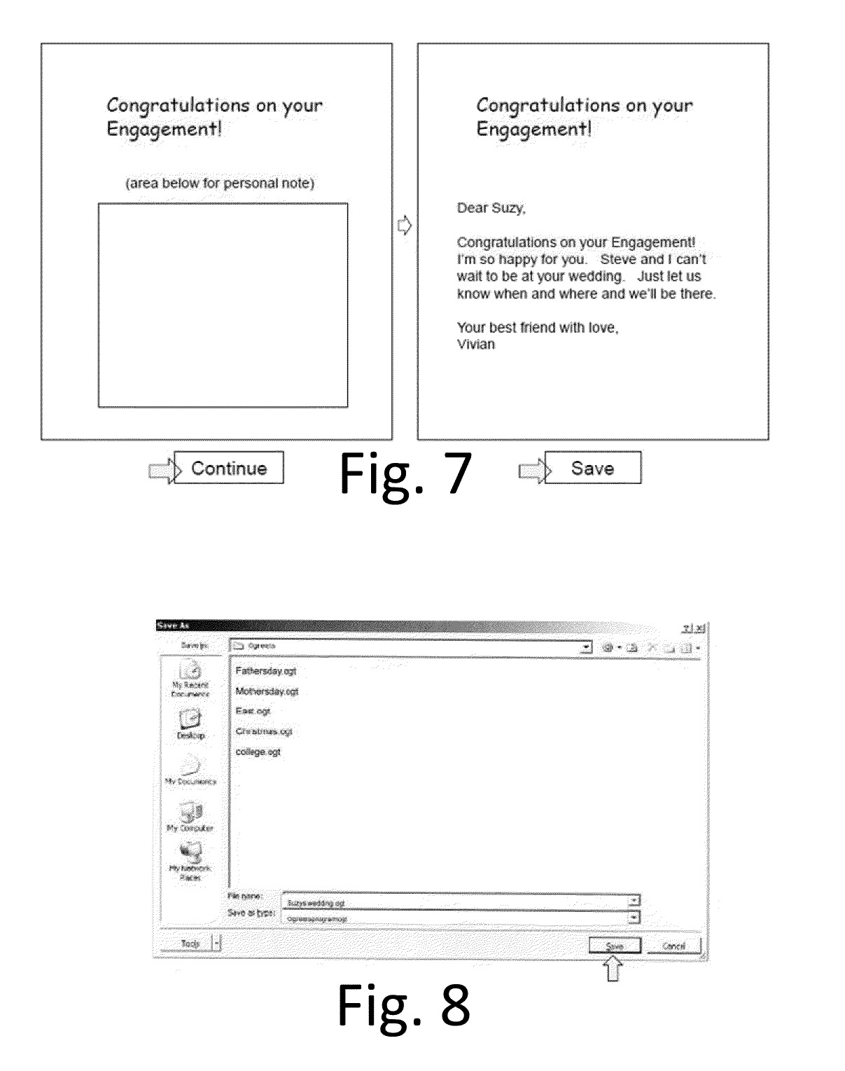

FIG. 7 illustrates two more pages of a greeting card before and after a personal note is added by the sender. On the left of FIG. 7, there is a space for the sender to enter a personal note, and on the right, there is a sample note prepared by the sender. If the sender is happy with the dialogue and what he/she has written then he/she should click on the ‘Save’ button. The card that is now displayed is what the recipient will see when he/she opens, with the only additional line that the recipient will see is ‘reply to sender’ which will appear right below the personal note.

FIG. 8 illustrates a window that opens after the sender selects the ‘Save’ button. The sender needs to select a file name and click ‘Save’ in this window to save the greeting card to a folder. The sender needs to save the greeting card his/her folder in order to use the card again to send it to someone else. After the sender saves the greeting card to a folder, the system automatically directs the sender back to where he/she was previously.

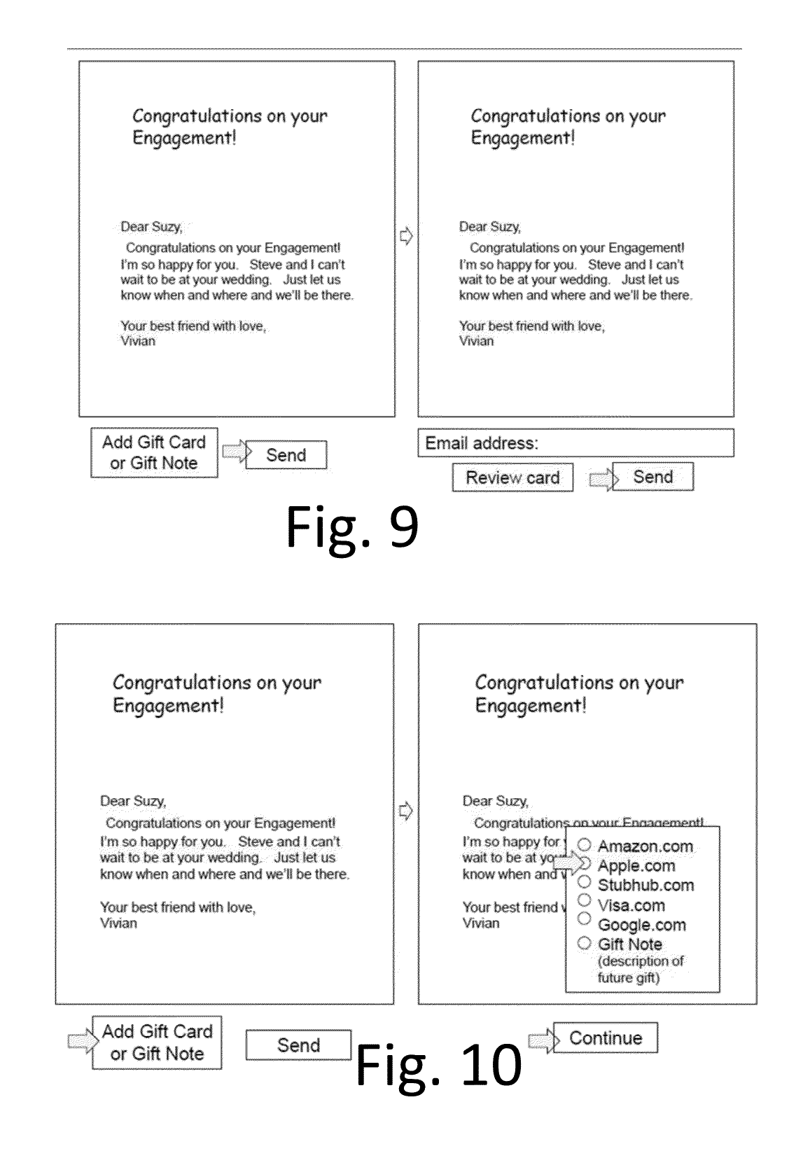

FIG. 9 illustrates pages that allow the sender to add a gift card or gift note and to review the greeting card. If the sender wants to add a gift card, he/she needs to click on the ‘Add Gift Card or Gift Note’ button. If not, the sender can choose ‘Send’, where the card will turn into an envelope and be added as an attachment to the sender's email after the email address of the intended receiver is typed in. There is also an option to ‘Review card’ prior to sending. When the greeting card is under review, the sender will see what the recipient will see (i.e. the finished card).

FIG. 10 illustrates options for the gift card or gift note. For example, the gift card can be from Amazon, Apple, Stubhub, Visa, Google, or a gift note. The gift note is a personalized description by the sender of a future gift. The sender may write in his/her own description, such as “one romantic dinner,” “a trip to Hawaii,” “a new set of your favorite golf clubs,” etc. If the sender wants to add a gift card he/she needs to click on the ‘Add Gift Card’ button. If the gift card option is chosen, a menu listing some online retailers will appear. In this example, Apple is chosen. The next step is to hit the ‘Continue’ button.

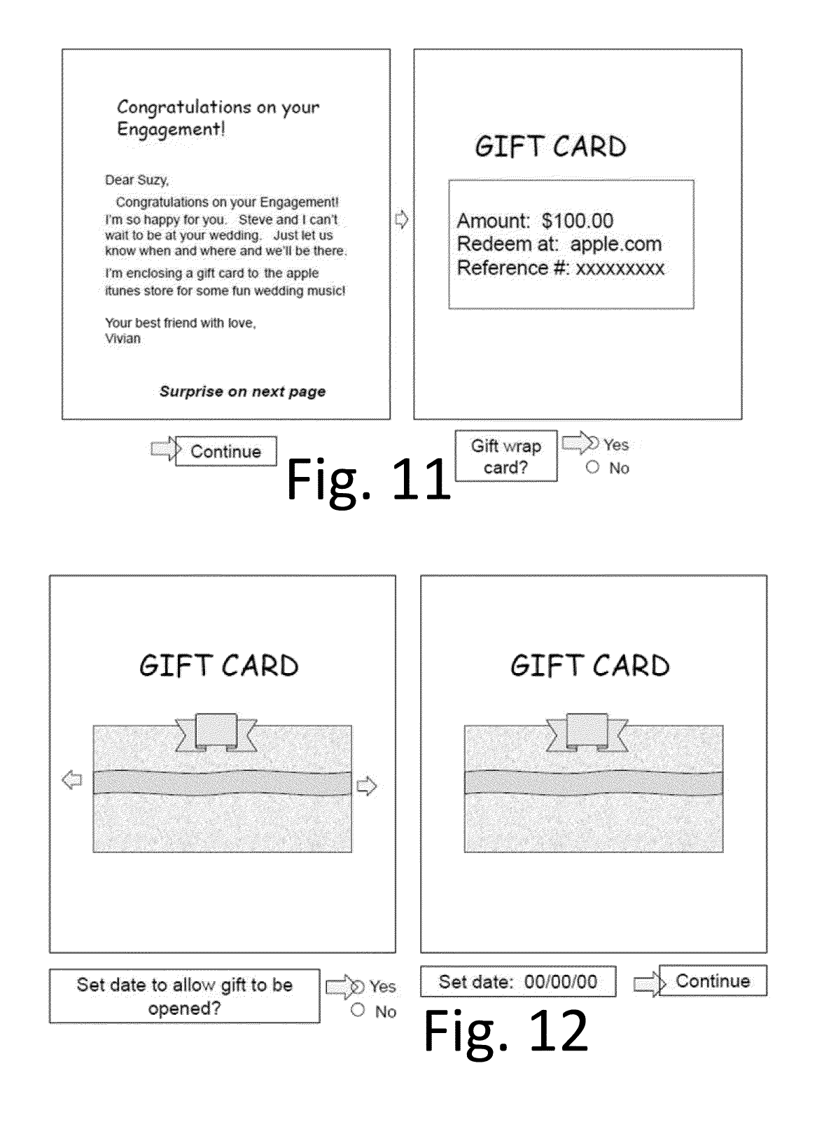

FIGS. 11-12 give the sender the option to wrap the gift card. In FIG. 11, if the sender wants to gift wrap the card, he/she needs to click on the ‘yes’ button. FIG. 12 provides wrapping options and an opening date. The sender can change the color/design of the wrapping paper by clicking on arrow icons located on the sides of the illustrated gift card. The gift card arrow icons allow the sender to go back if the sender likes a particular wrapping choice. Every click will change the color/design of the wrapping paper. If the sender wants to restrict the date which the gift can be opened, then he/she will need to add the opening date here. The recipient will not be able to open the gift prior to the date set.

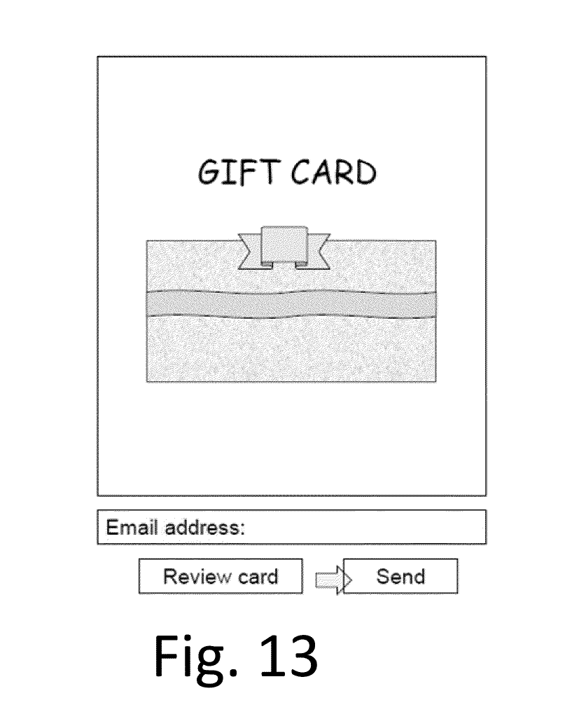

FIG. 13 gives the sender the option to review the finalized greeting card with an optional gift card prior to sending. After that, the greeting card is now ready to be sent. Once the email address is typed in, the ‘Send’ button needs to be clicked and the card will be sent to the intended recipient. The sender also has the option of review the final card by choosing the ‘Review card’ button.

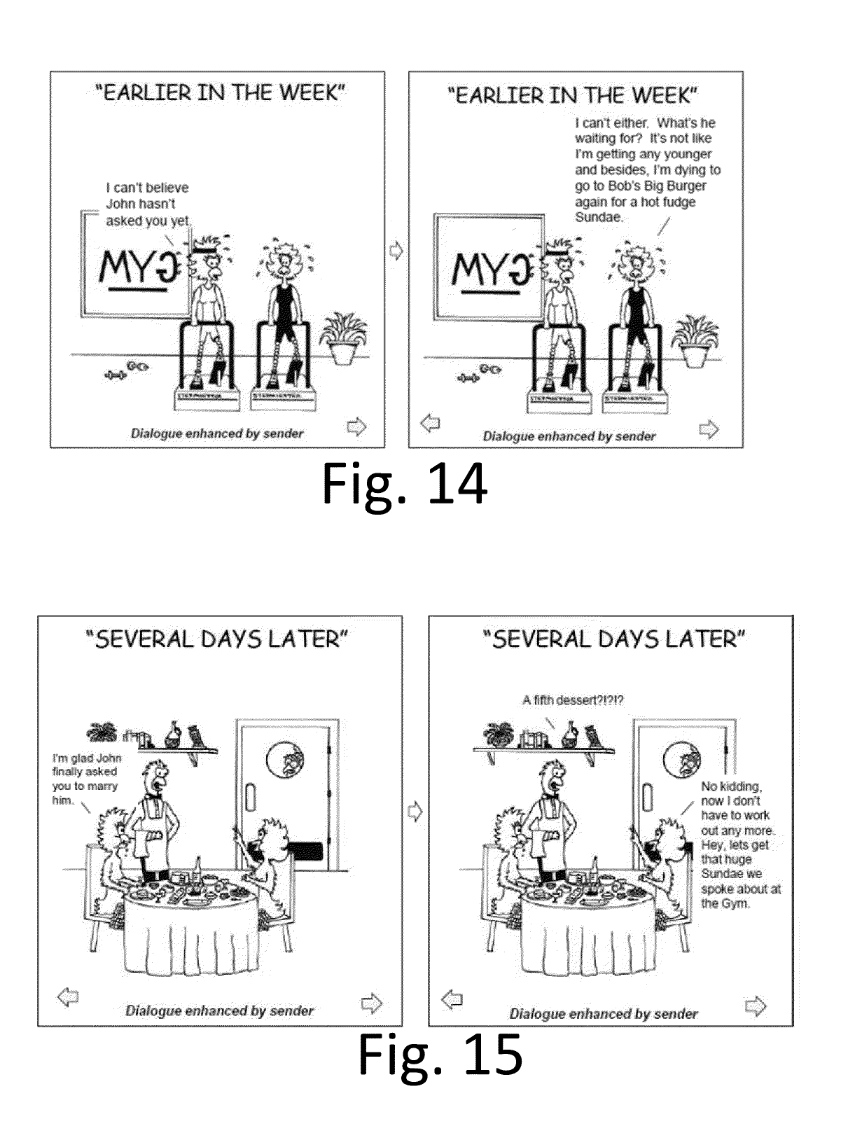

FIGS. 14-18 illustrate the sample greeting card from the recipient's perspective after the recipient opens the greeting card according to an embodiment of the invention. In FIG. 14, the recipient sees a first scene and pages with a header entitled “Earlier in the week.” The first scene has a first dialogue followed by a second dialogue. The recipient simply needs to touch/swipe the screen, hit enter, or click on the arrow button to move to the next dialogue and to the next scene. Both dialogues have been personalized by the sender, as the sender inserted at least the name “John,” “Bob's Big Burger” and “hot fudge Sundae.” This personalized dialogue is more meaningful to the recipient than a conventional greeting card, such as that illustrated on the left side of FIGS. 5-6.

FIG. 15 illustrates a second scene and pages entitled “Several days later.” In the second scene, there are three dialogues, all of which were modified by the Sender with at least the terms “John,” “dessert,” “Sundae” and “Gym.” To continue to the next dialogue and beyond the second scene, the recipient simply needs to touch/swipe the screen, hit enter, or click the arrow button to continue.

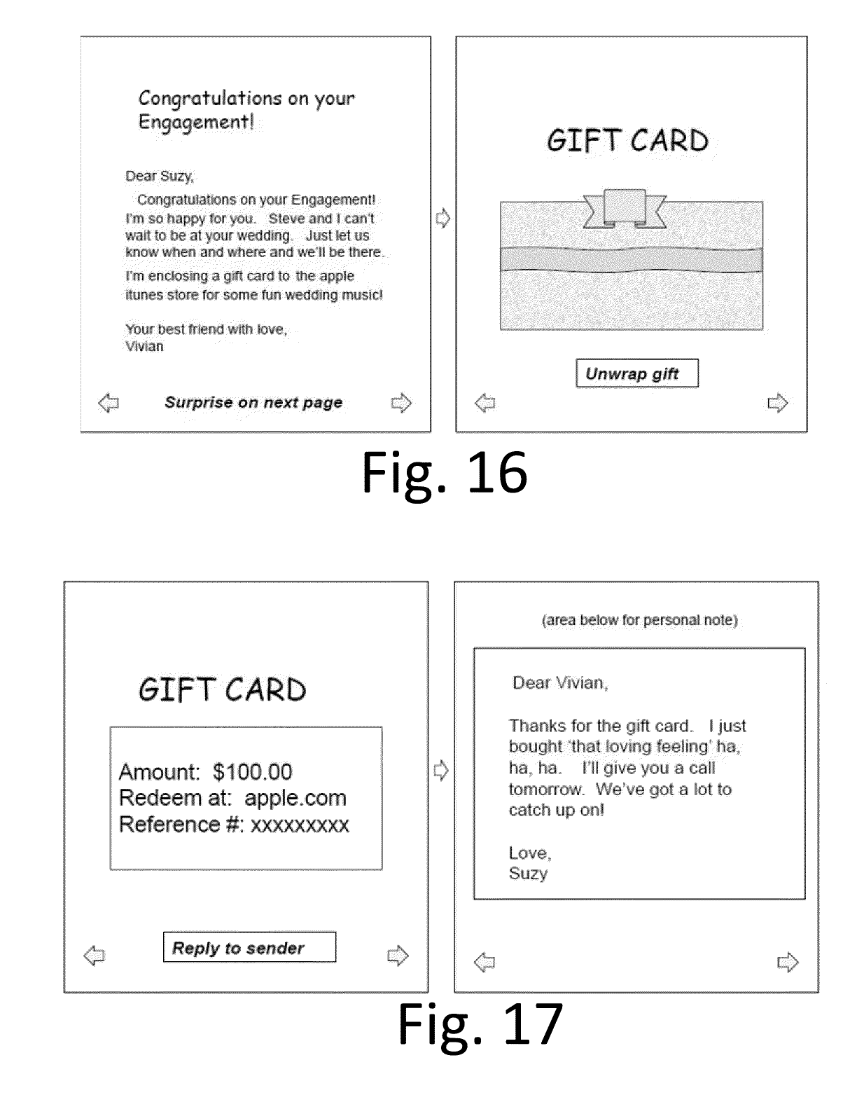

FIG. 16 illustrates two more pages of the greeting card. The page on the left illustrates the personal message created by the sender from scratch. The page on the right illustrates a wrapped gift card. Again, the recipient simply needs to touch/swipe the screen, hit enter, or click on the arrow button to continue through the pages of the greeting card. Additionally, in order for the recipient to unwrap the gift card, he/she can click on the ‘Unwrap gift’ button which will automatically lead to the next page.

FIG. 17 illustrates two more pages of the greeting card. The page on the left illustrates the unwrapped gift card which shows at least the merchant and the amount. The page on the right provides an opportunity for the recipient to reply to the sender by email. If the recipient wants to write a note back to sender, he/she needs to click on the ‘Reply to sender’ button which will lead the next page where he/she can write a personal note. Once the note is completed, he/she needs to touch/swipe the screen, hit enter or click on the arrow button to get to the next page.

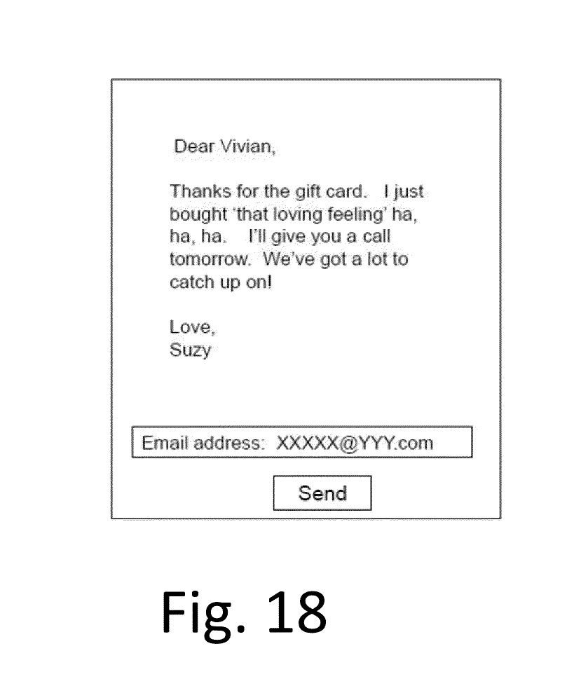

FIG. 18 illustrates the note created by the recipient of the greeting card. The sender's email address will be automatically populated. The email response is now ready for sending. The recipient simply needs to click on the ‘Send’ button and the email reply will be sent.

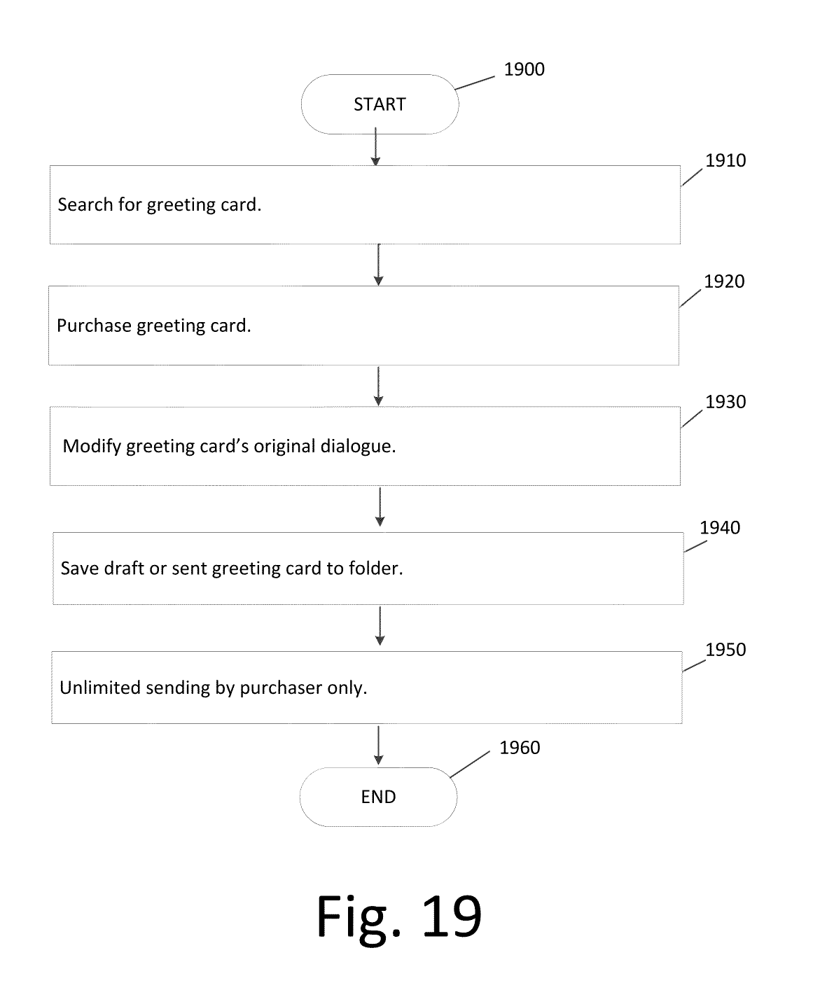

FIG. 19 illustrates a process of using the electronic greeting card system 100 according to an embodiment of the invention. The process starts at step 1900. At step 1910, the sender or another person searches for a greeting card. The sender can purchase the greeting card at step 1920. The sender can modify the greeting card's original dialogue at step 1930. This advantageously allows the sender to personalize content that is already professional and desirable. At step 1940, the sender can save a draft or final greeting card to a folder. At step 1950, the system 100 allows unlimited sending by the purchaser only. The process may be repeated recursively a number of times and ends at step 1960.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
a selection module configured to allow a sender to select an electronic greeting card having original dialogue;
a configuration module, wherein the configuration module allows the sender to modify the original dialogue of the electronic greeting card to create personalized dialogue on the electronic greeting card; and
a sending module configured to send the electronic greeting card.

2. The system of claim 1, wherein the sending module allows only the sender of the electronic greeting card to send the greeting an unlimited number of times.

3. The system of claim 2, wherein the sending module allows the sender to send an unlimited number of modifications of a purchased greeting card.

4. The system of claim 1, wherein the configuration module allows the sender to save a draft electronic greeting card to a folder.

5. The system of claim 1, wherein the sending module allows the sender to save a sent electronic greeting card to a folder.

6. The system of claim 1 further comprising an opening date for the electronic greeting card or a gift card accompanying the electronic greeting card, wherein the electronic greeting card or the gift card cannot be opened before the opening date.

7. The system of claim 1 further comprising a purchasing module that allows the sender to purchase or finalize a selection of the electronic greeting card.

8. The system of claim 1, wherein the configuration module allows the sender to add a gift card or a gift note, wherein the gift card or the gift note is configured to be visually displayed as an email attachment.

9. The system of claim 8, wherein the visual display comprises gift wrapping.

10. The system of claim 1, wherein the original dialogue or the personalized dialogue is dispersed among a plurality of pages or a plurality of scenes.

11. The system of claim 10, wherein a recipient advances through the plurality of pages or the plurality of scenes by hitting an enter button, clicking a continue button, clicking an arrow button, swiping a screen, or touching the screen.

12. A system comprising:
a configuration module, wherein the configuration module receives an electronic greeting card selected by a sender having original dialogue, wherein the configuration module allows the sender to modify the original dialogue of the electronic greeting card to create personalized dialogue on the electronic greeting card;
a purchasing module that allows the sender to purchase or finalize a selection of the electronic greeting card; and
a sending module configured to send the electronic greeting card.

13. The system of claim 12, wherein the sending module allows only the sender of the electronic greeting card to send the greeting an unlimited number of times.

14. The system of claim 12, wherein the configuration module allows the sender to save a draft electronic greeting card or a sent electronic greeting card to a folder.

15. A method comprising:
receiving an electronic greeting card selected by a sender having original dialogue;
modifying the original dialogue of the electronic greeting card to create personalized dialogue on the electronic greeting card; and
sending the electronic greeting card to a recipient.

16. The method of claim 15 further comprising allowing only the sender to send the greeting an unlimited number of times.

17. The method of claim 15 further comprising allowing the sender to save a draft electronic greeting card or a sent electronic greeting card to a folder.
